(19) United States
(12) Patent Application Publication
(10) Pub. No.: US 2009/0014674 A1
(43) Pub. Date: Jan. 15, 2009

(54) Valve regulation assembly

(75) Inventors: Thomas A. Grissom, Dexter, MI (US); Murray Busato, Clinton Township, MI (US); Robert J. Telep, Livonia, MI (US)

Correspondence Address: WARN, HOFFMANN, MILLER & LALONE, .P.C, PO BOX 70098, ROCHESTER HILLS, MI, 48307, US

(73) Assignee: BorgWarner Inc., Auburn Hills, MI (US)

(21) Appl. No.: 12/217,596

(22) Filed: Jul. 7, 2008

Related U.S. Application Data
(63) Continuation-in-part of application No. 11/125,959, filed on May 10, 2005.

(51) Int. Cl. F16K 1/20; B23P 15/00

(52) U.S. Cl. 251/298; 251/299; 29/890.12

(57) ABSTRACT

The present invention is directed to a bypass valve assembly having a valve housing with an inlet port, outlet port, and bypass port all formed within the valve housing. A valve member is operably connected to the valve housing and includes a first valve plate and second valve plate that face in substantially opposite directions from each other. The first valve plate articulates to form a tight barrier with the outlet port when the valve member is in a first position, and the second valve plate articulates to form a tight barrier with the bypass port when the valve member is in a second position.

### CROSS-REFERENCE TO RELATED APPLICATIONS

This application is a continuation-in-part of U.S. Non-Provisional patent application Ser. No. 11/125,959 filed on May 10, 2005.

### FIELD OF THE INVENTION

The present invention relates to a control valve for a motor vehicle, more specifically, a bypass valve assembly to selectively direct a fluid medium flow.

### BACKGROUND OF THE INVENTION

Two-stage turbochargers are commonly known and are used in all kinds of engines. They consist of a high-pressure (HP) turbine, and a low-pressure (LP) turbine, with each turbine having its own compressor. The HP turbine is typically smaller than the LP turbine, and rotates at faster speeds. During normal operating conditions, when the engine runs at lower speeds, (such as at a stop light), the only turbine in use is the HP turbine. When the engine is running at lower speeds, it creates less exhaust gas energy. This lower amount of exhaust gas energy is not enough to power the larger, LP turbine, but it does provide enough energy to power the smaller, HP turbine. During operation, as the engine begins to increase speed, the HP turbine is operated by the lower energy exhaust gases, but after the engine reaches a certain speed, the HP turbine no longer provides enough boost pressure to have any effect on engine performance. When this occurs, the LP turbine begins to operate and generate the higher level of boost pressure that the HP turbine cannot generate. Increasing engine speed also increases the exhaust gas energy, which is necessary to operate the LP turbine.

One common problem with this type of method of turbocharging is a phenomenon called “turbo lag.” Turbo lag refers to the moment in operation where the HP turbine stops having an effect on engine performance, and the LP turbine begins to have an effect on engine performance. Typically, the method for directing the exhaust gas from one turbine to the next is controlled by a valve. When the HP turbine is operating at maximum boost pressure, and no longer increases engine power, the valve will open. At this moment in operation, there is still not enough exhaust gas energy to operate the LP turbine. As the engine speed keeps increasing with acceleration, the exhaust gas energy increases to begin to cause the LP turbine to have an effect on engine performance. The time frame from which the valve opens, to the point where the LP turbine beings to have an effect on engine power is the period where turbo lag occurs. During this period, the driver of the vehicle will experience a reduction in engine power, while the LP turbine begins to operate. This condition is considered undesirable, and several forms of prior art have been developed to provide a smooth transition from the HP turbine to the LP turbine, thereby providing a smoother power increase to the engine.

Another common problem with two-stage turbochargers occurs at higher engine speed, when the HP turbine is not cut off from the air flow of the exhaust gas. During this condition, sometimes called “overspeed,” the increased exhaust gas energy can cause the HP turbine to spin at speeds which may cause damage. Control valves of two-stage series turbocharger systems have been applied to modulate the amount of exhaust gas pressure flowing into the LP turbine. These valves typically have been used for closing off exhaust gas flow to the LP turbine thereby only allowing the exhaust gas to flow only to the HP turbine until the HP turbine is no longer effective, at which point the valve opens a pathway to allow air to flow to the LP turbine. This is beneficial in providing boost pressure at low engine speeds, but does not aid preventing overspeed of the HP turbine.

Accordingly, there exists a need for an improvement in transitioning from the HP turbine to the LP turbine in a two-stage turbocharger system, as well as an improvement in the prevention in overspeed in a HP turbine.

Due to both federal and state regulations, the emissions allowed to be released during operation of motorized vehicles today are limited. One way to control the emissions released by the vehicle is to include an air management arrangement including a bypass valve and an exhaust gas recirculation unit (EGR). Generally, EGR bypass valves are used to recirculate exhaust gas back to the intake manifold of the engine. During periods when the exhaust gas temperature and pressure is high, such as when the engine speed increases with acceleration, the bypass valve can direct the exhaust gas through one outlet port to the EGR cooler chamber. During periods of low exhaust temperature and pressure, the bypass valve can direct the exhaust gas through the bypass port bypassing the EGR cooler chamber and entering the remaining components of the exhaust system.

A common problem with bypass valves is that they do not provide a tight seal or barrier with the two outlet ports since the bypass valves do not articulate in response to all seal surface geometries which can change due to thermal expansion as well as build-up of oil, dirt, grim, and the like.

Accordingly, there exists a need for an improved exhaust bypass unit having a valve unit used to fully restrict exhaust gas flow from passing through the selected cooler port or the selected bypass port.

### SUMMARY OF THE INVENTION

The present invention is directed to a bypass valve assembly having a valve housing with an inlet port, outlet port, and bypass port all formed within the valve housing. A valve member is operably connected to the valve housing and includes a first valve plate and second valve plate that face in substantially opposite directions from each other. The first valve plate articulates to form a tight barrier with the outlet port when the valve member is in a first position, and the second valve plate articulates to form a tight barrier with the bypass port when the valve member is in a second position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a two-stage turbocharger unit having the present invention used in an engine with one exhaust bank;

FIG. 2 is a schematic view of a two-stage turbocharger unit having the present invention used in an engine with two exhaust banks;

FIG. 3 is a top view of the valve assembly portion of the present invention;

FIG. 4 is a bottom view of the valve assembly portion of the present invention;

FIG. 5 is a side view of the valve assembly portion of the present invention;

FIG. 6 is a cut-away side view of the valve assembly portion of the present invention with the valve in a position to block off the exhaust gas inlet port;

FIG. 7 is a cut-away side view of the valve assembly portion of the present invention with the valve in a position to block off the HP turbine inlet port; and

FIG. 8 is a cut-away side view of the valve assembly portion of the present invention with the valve in an intermediate position.

FIG. 9 is a perspective view of a valve assembly and showing an actuator, according to an alternative embodiment of the present invention;

FIG. 10 is a side view of the valve assembly showing the valve member portion of the present invention with a valve plate in a position to block off a bypass port and showing the rotation of the valve member in phantom, according to the alternative embodiment of the present invention;

FIG. 11 is an exploded perspective view of the valve assembly according to the alternative embodiment of the present invention;

FIG. 12(a) is a perspective view of the valve member portion, according to the alternative embodiment of the present invention;

FIG. 12(b) is a perspective view of the valve member portion, according to an alternative embodiment of the present invention;

FIG. 13(a) is a perspective view of the valve member illustrating a second valve plate contacting a first plane associated with a second seating surface, according to the present invention;

FIG. 13(b) is a perspective view of the valve member illustrating the second valve plate articulating in response to a second plane associated with a second seating surface, according to the present invention.

FIG. 14 is an exploded view of an alternative embodiment of the valve member portion having a pin flange, according to an embodiment of the present invention;

FIG. 15 is a schematic diagram illustrating the valve assembly in fluid communication with a downstream path and a bypass path, according to an embodiment of the present invention;

FIG. 16 is a schematic diagram illustrating articulation of the first and second valve plates, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

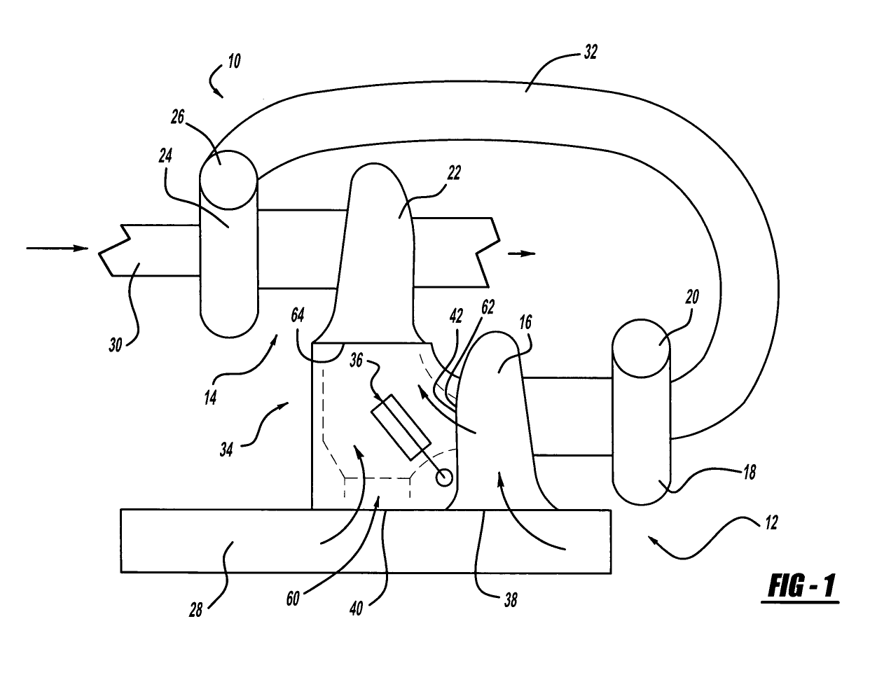

Referring to FIG. 1, a two-stage exhaust gas turbocharger unit is generally shown at 10, comprised of a high-pressure (HP) turbocharger unit 12, and a low-pressure (LP) turbocharger unit 14. The HP turbocharger unit 12 includes a HP turbine 16, and an HP compressor 18 having an outlet port 20. Similarly, the LP turbocharger unit 14 includes a LP turbine 22 and a LP compressor 24 having an outlet port 26. The LP turbine 22 is mounted on an exhaust manifold 28. The LP compressor 24 is connected to an intake line 30, which is connected at the center of LP compressor 24. An intake conduit 32 is connected to outlet port 26 on a first end, and is connected to the center of HP turbine 18 on a second end.

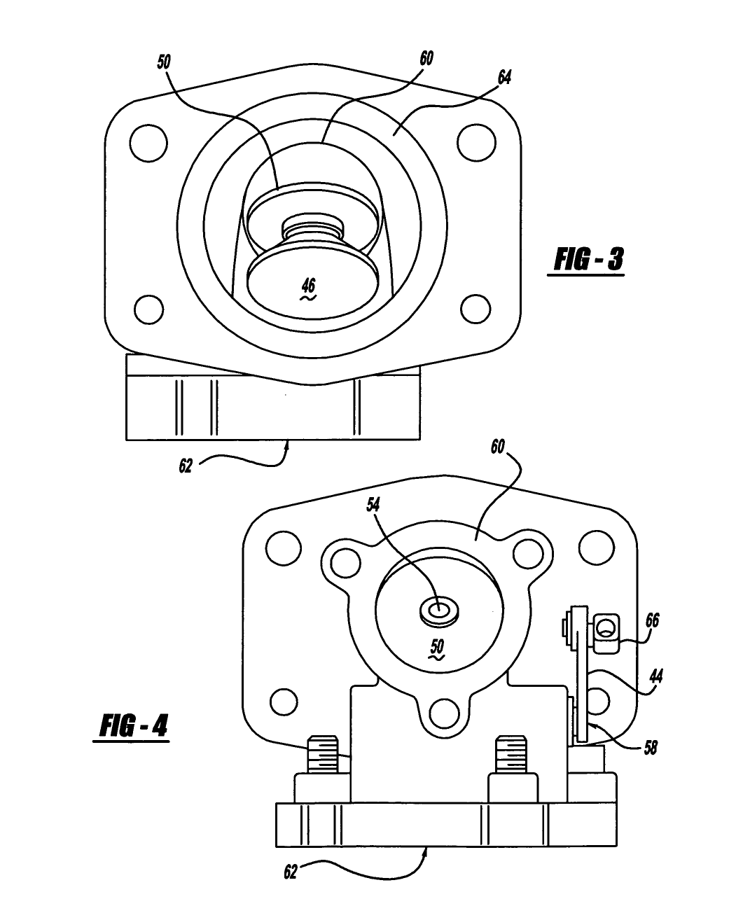

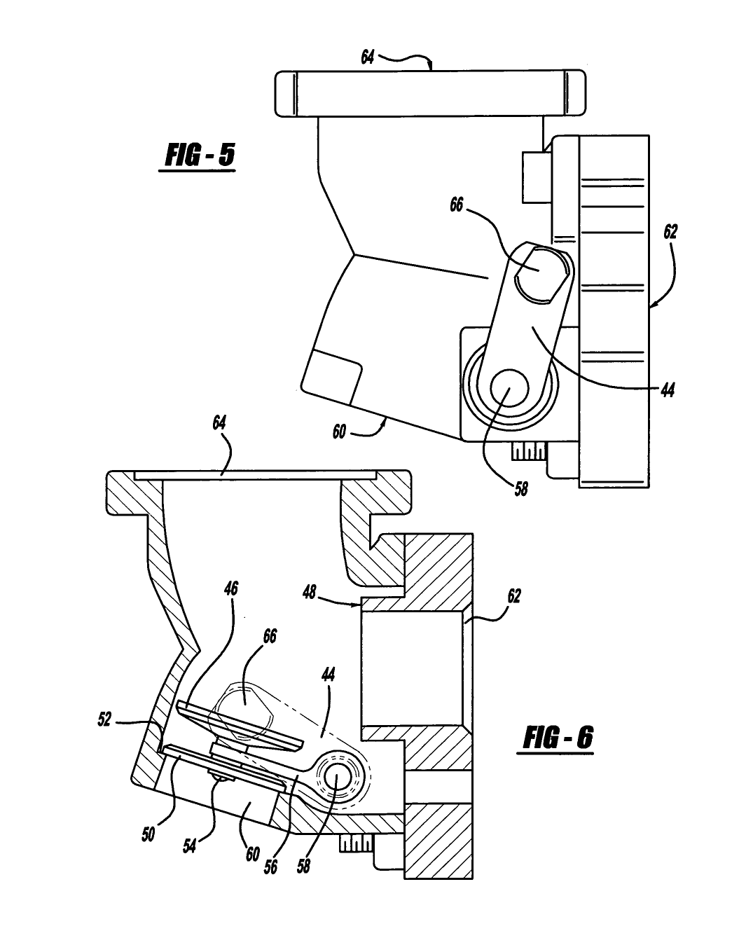

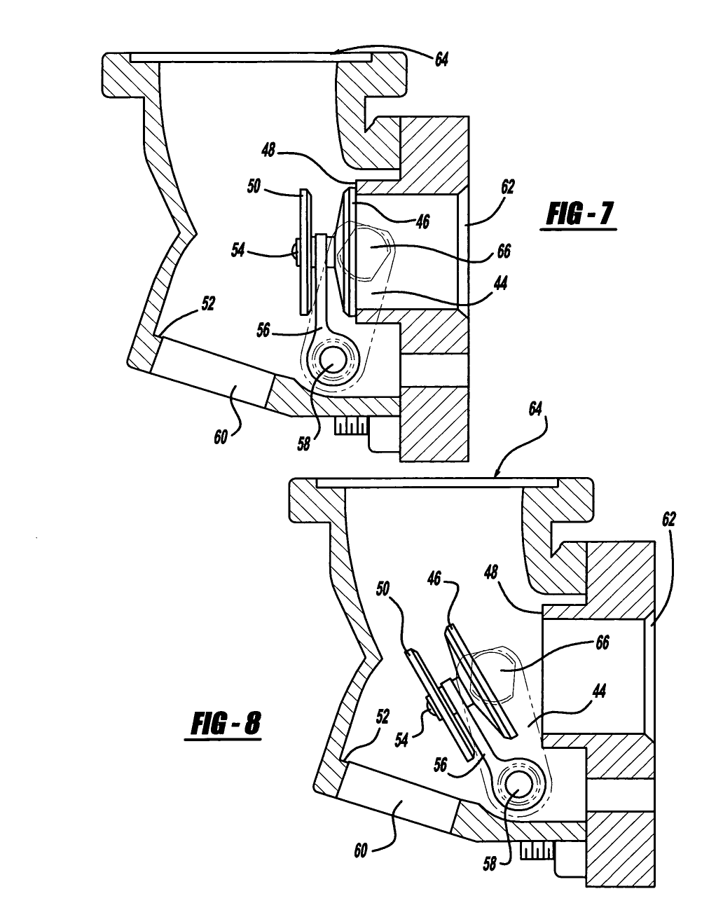

The HP turbine 16 and the LP turbine 22 are connected by a valve assembly 34 having a valve 36, shown in FIG. 1, and in FIGS. 3-8. The valve assembly 34 is mounted on the exhaust manifold 28 and receives exhaust gases from either the second exhaust manifold outlet 40 or the HP turbine outlet 42. The valve assembly 34 is also comprised of a lever 44, a first valve plate 46 that works in conjunction with a first contact surface 48, and second valve plate 50 that works in conjunction with a second contact surface 52. The first valve plate 46 and the second valve plate 50 face in opposite directions of each other, and are connected by a pin 54, and are mounted onto a pivot arm 56. The pivot arm 56 is fixed for rotation upon a hinge assembly 58. The valve assembly 34 also includes an exhaust gas inlet port 60, an HP turbine inlet port 62, an LP turbine outlet port 64, and a rotatable connector 66. The rotatable connector 66 is connected to an actuator which can be hydraulic, pneumatic, or some other type of device controlled by the vehicle's electronic control unit.

The operation of the present invention configured for a single-bank exhaust system as shown in FIG. 1 will now be described. During low engine speed operation, the valve 36 is used to close off the exhaust gas inlet port 60 when the vehicle is first beginning to accelerate, and exhaust gas pressure is low, forcing all of the exhaust gas through the HP turbine 16. When the valve 36 is configured in this manner, the exhaust gas flows from the exhaust manifold 28, through the first exhaust manifold outlet 38, through the HP turbine 16, through the HP turbine outlet 42, through the HP turbine inlet port 62 and into the valve assembly 34. The valve assembly 34 then directs the exhaust gas into the LP turbine 22, where it is then passed into the remaining components of the exhaust system. As all of the exhaust gas is being forced through the HP turbine 16, fresh air flows through the intake line 30, passing through the LP compressor 24, and through outlet port 26. The air then flows through the intake conduit 32, and into the HP compressor 18. The HP compressor 18 compresses the fresh air received from the intake conduit 32, and forces it into the intake manifold of the engine.

During the process where all of the exhaust gas is being directed toward the HP turbine, the LP compressor 24 is not activated because it is controlled by the LP turbine 22, which is also not activated. The LP turbine 22 is larger in size compared to the HP turbine 16, and the LP compressor 24 is larger than the HP compressor 18. Neither are activated during this process because at lower engine speeds the volume of exhaust gas flow is not high enough to activate the LP turbine 22, and the volume of fresh air flowing into the system is not high enough for LP compressor 24 to effectively compress it. Directing all of the exhaust gas flow into the smaller HP turbine 16 allows the HP compressor 18 to provide the necessary amount of compressed air to flow into the intake manifold of the engine, increasing engine power at low engine speeds.

As the engine speed increases and the vehicle accelerates, the smaller HP turbine 16 and HP compressor 18 become less and less effective. When the engine speed increases to a certain predetermined value, the vehicle's electronic control unit commands the actuator to open the valve 36, lifting the second valve plate 50 away from the second contact surface 52, allowing exhaust gas from the exhaust manifold 28 to flow through the second exhaust manifold outlet 40, through the exhaust gas inlet port 60, and then through the valve assembly 34. The exhaust gas then exits through the LP turbine outlet port 64 of the valve assembly 34 and flows into the LP turbine 22, the exhaust gas then flows into the remaining exhaust system components. As the LP turbine 22 is activated from the increased exhaust gas pressure, the LP compressor 24 will begin to compress air coming in from the intake line 30. The compressed air is then forced through the outlet port 26 and into the intake conduit 32, where it then flows through the HP compressor 18, through the outlet port 20, and into the intake manifold of the engine. During this portion of operation, the air coming into the HP compressor 18 has already been pressurized by the LP compressor 24.

As the engine speed continues to increase, the valve 36 continues to rotate further away from the exhaust gas inlet port 60, and moves closer to the HP turbine inlet port 62. When it becomes necessary to direct all of the exhaust gas to flow directly into the LP turbine 22, the valve 36 moves into a position where the first valve plate 46 comes in contact with the first contact surface 48. When the valve 36 is in this position, exhaust gas cannot flow from the HP turbine 16 into the valve assembly 34. All of the exhaust gas flows from the exhaust manifold 28, through the second exhaust manifold outlet 40, and into the valve assembly 34. The valve 36 can be controlled by an actuator, or some other device, connected to the rotatable connector 66, which rotates the lever 44, thereby rotating the valve 36.

When closing off the second exhaust manifold outlet 40 or the HP turbine outlet 42, the valve 36 provides a smooth transition from the exhaust gas flowing through the HP turbine 16 to the LP turbine 22, and can be moved to any position therebetween to direct the flow of exhaust gas as driving conditions mandate.

It should also be noted that another advantage of the present invention is the orientation of the valve assembly 34 in relation to the HP turbine 16 and the LP turbine 22. The valve 36 is located in a position where the flow of exhaust gas pushes on the valve 36 when the first valve plate 46 is pressed against the first contact surface 48 and when the second valve plate 50 is pressed against the second contact surface 52. This also occurs when the valve 36 is located in any position therebetween. Also, the hinge assembly 58 is located in a position between the HP turbine outlet 42, and the second exhaust manifold outlet 40. Locating the hinge assembly 58 in this position allows for a single valve to be used for directing exhaust gas flow to either the HP turbine 16 or the LP turbine 22. Also, the valve assembly 34 is not only used for directing exhaust gas flow to each of the turbines, but the valve assembly 34 can also stop the flow of exhaust gas into the HP turbine 16, preventing overspeed and damage. Additionally, locating the valve 36 in the aforementioned position allows for greater control of the exhaust gas flow than compared to, for example, if the valve 36 were positioned in front of the second exhaust manifold outlet 40 or in front of the HP turbine outlet 42.

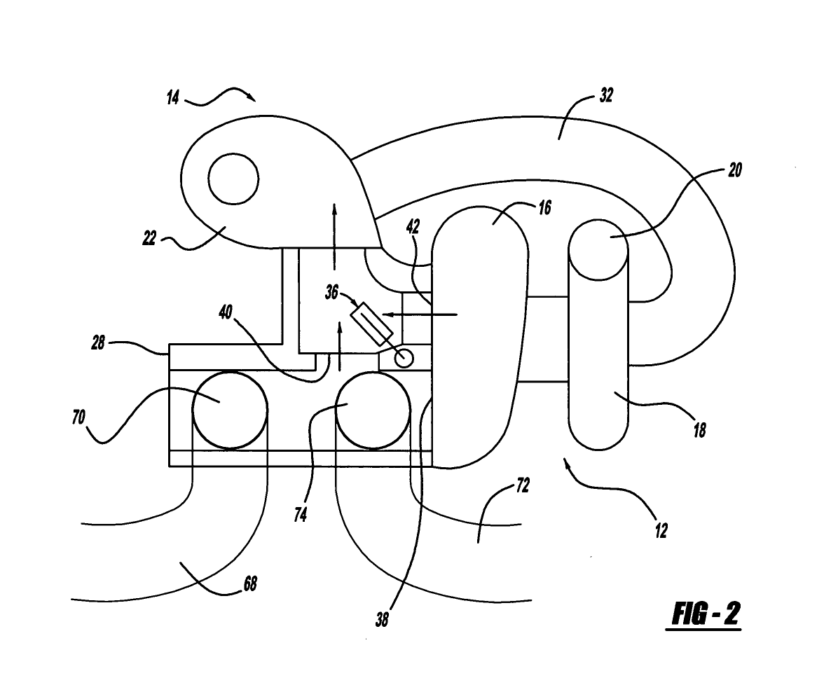

The present invention can also be used with engines having two exhaust banks, such as with a “V-6” or “V-8” engine. This embodiment is shown in FIG. 2, and is similar to the embodiment shown in FIG. 1, wherein like numbers refer to like elements. In addition, this embodiment also includes a first exhaust tube 68 connected to a first exhaust bank and a first opening 70, as well as a second exhaust tube 72 connected to a second exhaust bank and a second opening 74. In this embodiment, exhaust gas flows from the first exhaust tube 68 into the first opening 70, and from the second exhaust tube 72 into the second opening 74. The exhaust gas then flows into the exhaust manifold 28 where it is directed to flow into either the HP turbine 16 or the LP turbine 22 through the use of the valve assembly 34. The remaining operations of the HP turbocharger unit 12, the LP turbocharger unit 14 and the valve assembly 34 remain the same as mentioned in the previous embodiment.

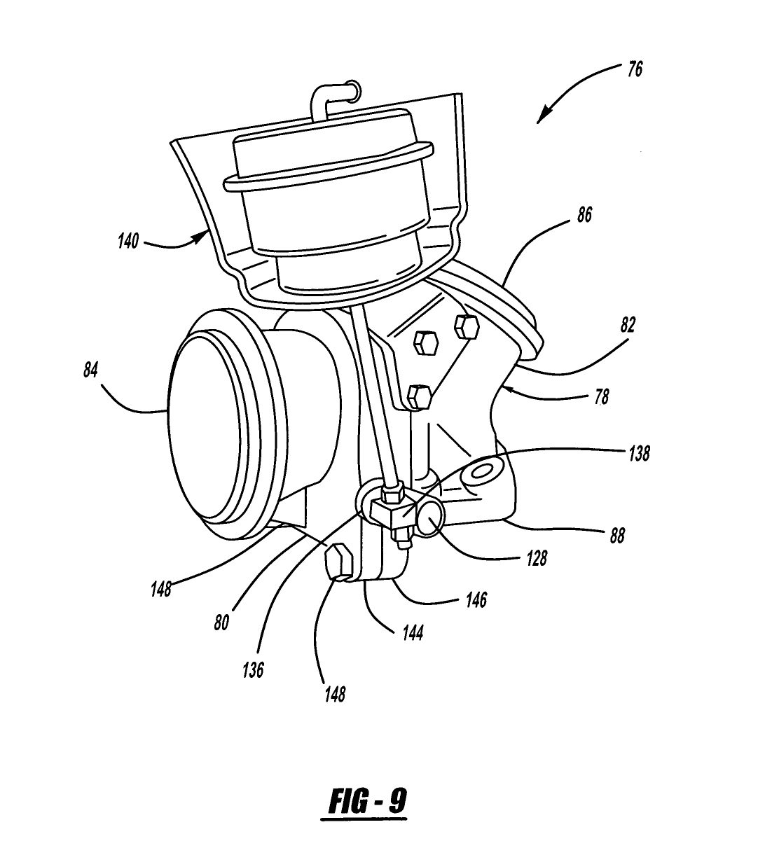

Referring generally to FIGS. 9-16, and more specifically to FIGS. 9-10 and 15, in an alternative embodiment a bypass valve assembly 76 is generally shown, having a valve housing 78 that includes a first housing 80 operably connected to a second housing 82. The first housing 80 includes an outlet port 84, and the second housing 82 includes an inlet port 86 operable to receive a fluid medium from a source and a bypass port 88 disposed between the inlet port 86 and the outlet port 84. The fluid medium, including an exhaust gas, oil, and the like, received by the inlet port 86 selectively passes either entirely through the outlet port 84, entirely through the bypass port 88, or through each simultaneously. As illustrated in the schematic of FIG. 15, the outlet port 84 is in fluid communication with a downstream path 90, which receives and transports the fluid medium that passes through the outlet port 84. The downstream path 90 includes a structure 92 located at some distance between the bypass valve assembly 76 and an exit 94. The exit 94 can lead into an intake manifold, exhaust manifold, atmosphere, and the like. The structure 92 can be a turbocharger, a cooler, another bypass path, valve, and the like. The bypass port 88 is in fluid communication with a bypass path 96 which receives fluid medium passing through the bypass port 88. The bypass path 96 bypasses the fluid medium at least partly around the downstream path 90 to a location downstream from the structure 92. In operation, fluid medium received from the inlet port 86 is selectively directed to flow either through the bypass port 88 leading to the bypass path 96, thereby bypassing the structure 92, or through the outlet port 84 to the downstream path 90 that flows into the structure 92. It is understood that alternatively a percentage of fluid medium is selectively directed through the outlet port and inlet port simultaneously.

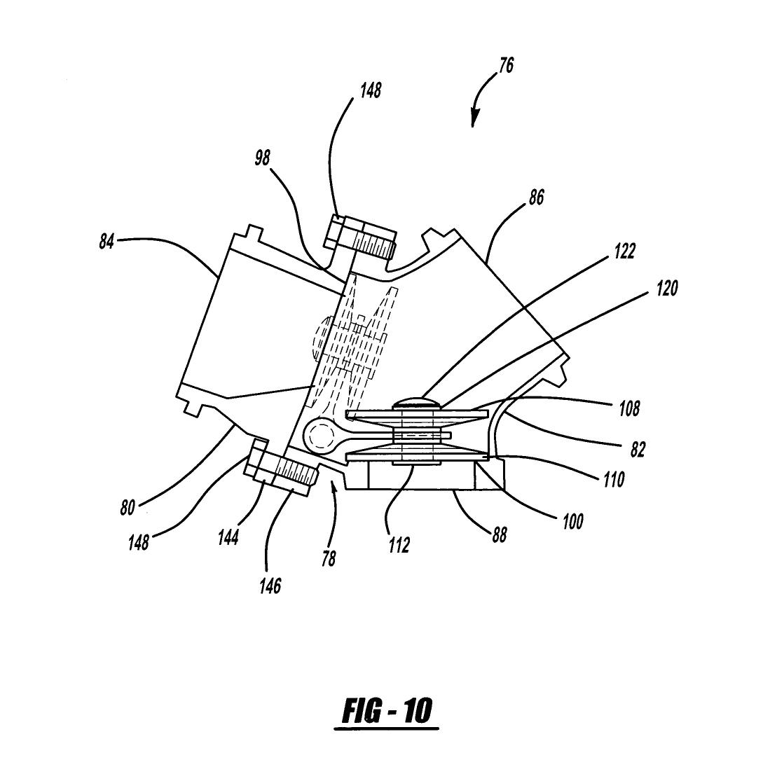

Referring generally to FIGS. 9-16, the valve housing 78 also includes a first seating surface 98 formed in the first housing 80 and a second seating surface 100 formed in the second housing 82. The first seating surface 98 defines an opening of the outlet port 84, and the second seating surface 100 defines a second opening of the bypass port 88. A valve member 106 is operably mounted inside the valve housing 78 and is operable to pivot from a first position relative to the outlet port 84, a second position relative to the bypass port 88 (illustrated in phantom in FIG. 10), and intermediate positions therebetween. The valve member 106 includes a first valve plate 108 and a second valve plate 110 which face in substantially opposite directions from each other. The first and second valve plates 108, 110 can articulate in response to the seating surface geometries of the first and second seating surface 98, 100 respectively in order to create a tight seal or barrier for restricting the flow of the fluid medium.

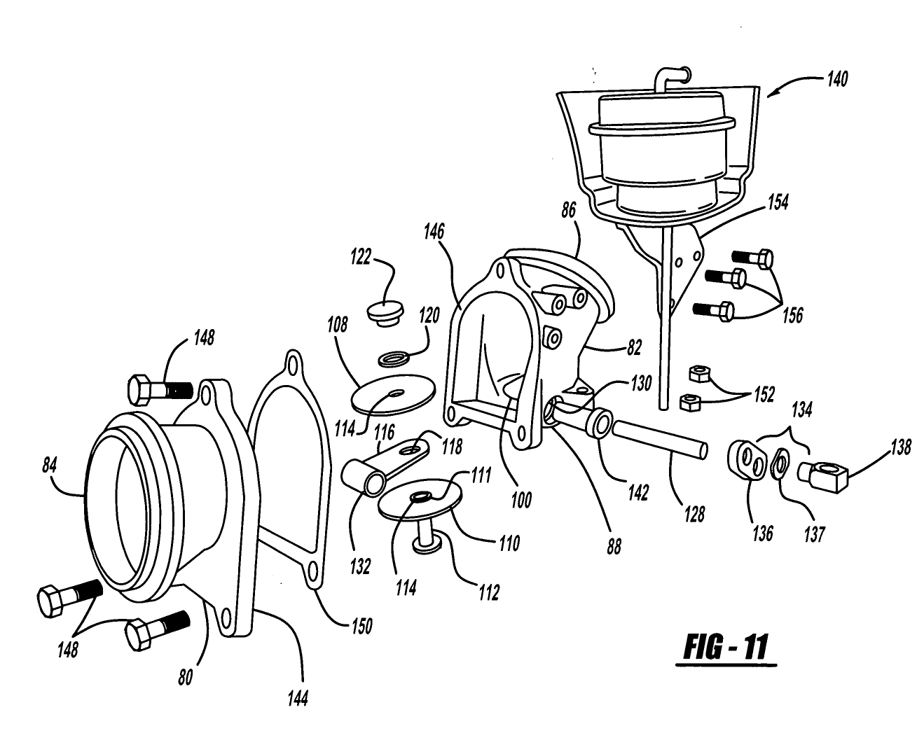

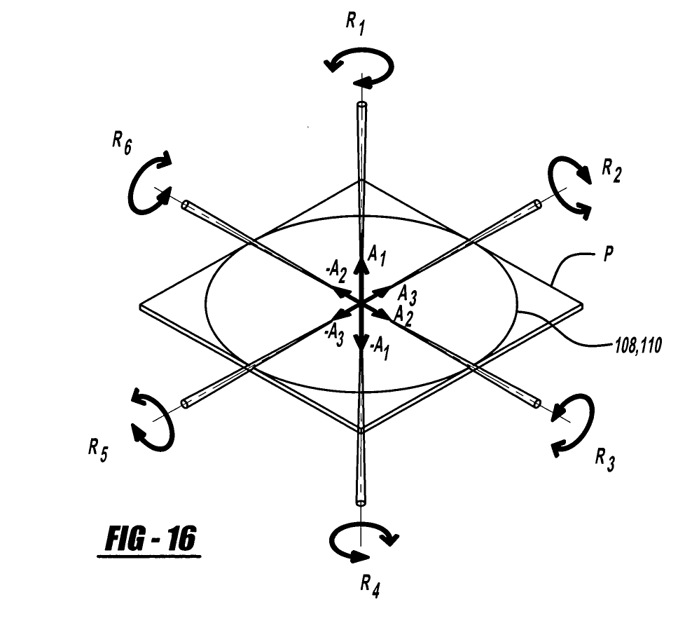

In further regard to FIGS. 11-14, and more particularly to FIGS. 11-12(a), a pivot arm 116 is disposed between the first and second valve plates 108, 110. The first and second valve plates 108, 110 are slidably connected to the pivot arm 116 and are operably coupled together by a pin 112 that is inserted through a centrally located aperture 114 disposed on both the first and second valve plates 108, 110. Raised bosses 109, 111 formed on the first and second valve plates 108, 110 respectively are adapted to receive the pin 112 and are opposingly disposed in a pivot arm aperture 118 portion located at one end of the pivot arm 116. The pin 112 is disposed substantially perpendicular to a plane passing along the first and second seating surfaces 98, 100 when the valve member 106 is pivoted to the first position and the second position respectively. The first and second valve plates 108, 110 can rotate 360 degrees about the circumference of the pin 112 and can operably slide with respect to the longitudinal axis of the pin 112 to accommodate 360 degree pivoting of the first and second valve plates 108, 110 about the circumference of the pin 112. By way of non-limiting example, FIG. 16 illustrates an example of articulation of the first and second valve plates 108, 110 in a radial, axial, and multi-axis-angular direction, wherein a circle representing the first and second valve plates 108, 110 is shown articulating relative to a fixed plane, p. Lines A1, −A1, A2, −A2, A3, and −A3 represent three axes that the first and second valve plates 108, 110 can move along. R1 through R6 represent six axes about which the first and second valve plates 108, 110 can rotate.

The pin 112 can have one wider end that prevents the first or second valve plate 108, 110 from sliding off of the pin 112. To prevent the opposing first or second valve plate 108, 110 from sliding off of the pin 112, an optional washer 120 is followed by an end cap 122 disposed at the opposite end of the pin 112. It is understood that alternatively the first and second valve plates 108, 110 can be secured by eliminating the optional washer 120 and forming or machining an end cap 122 on at least one of the ends of the pin 112. It is further understood that the raised bosses 109, 111 can alternatively be a single piece formed on either the first or second valve plate 108, 110 and also integrally formed with the pin 112. See FIG. 12(b). FIG. 12(b) illustrates pin 112 and bosses 109, 111 formed as an integral portion of the second valve plate 110. As shown, the raised bosses 109, 111 of the second valve plate 110 are at least partly disposed within pivot arm aperture 118 and pin 112 is disposed through the aperture 114 of the first valve plate 108.

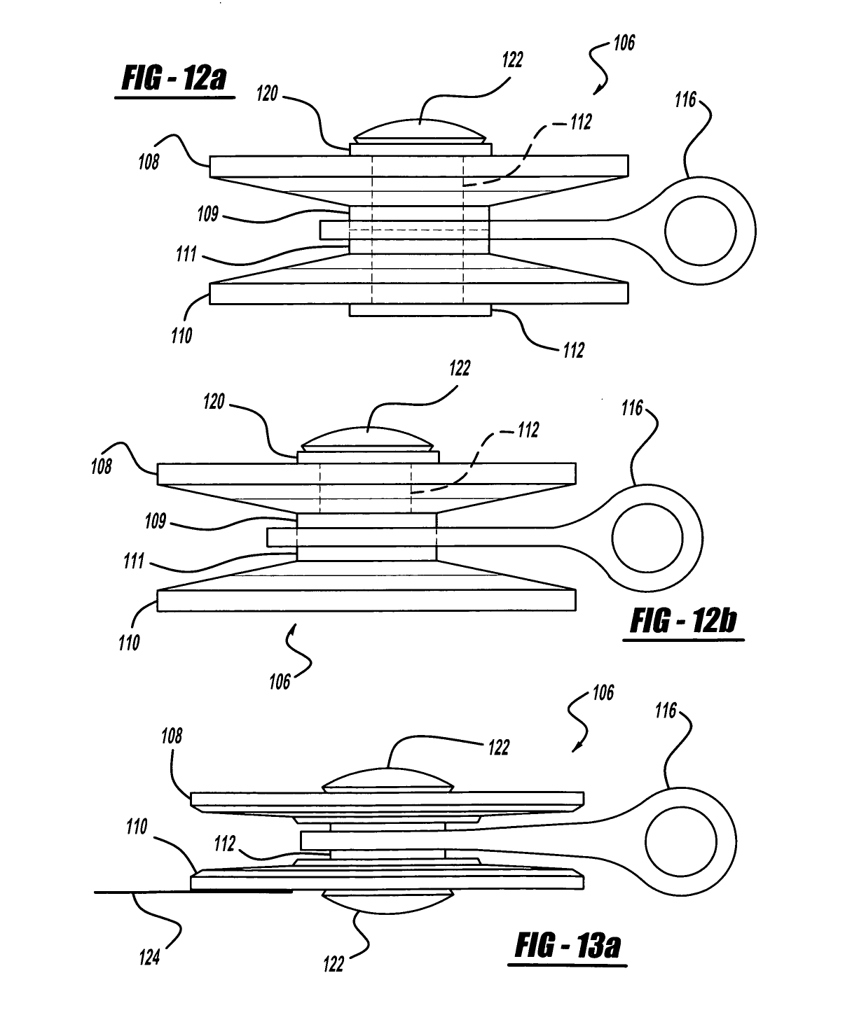

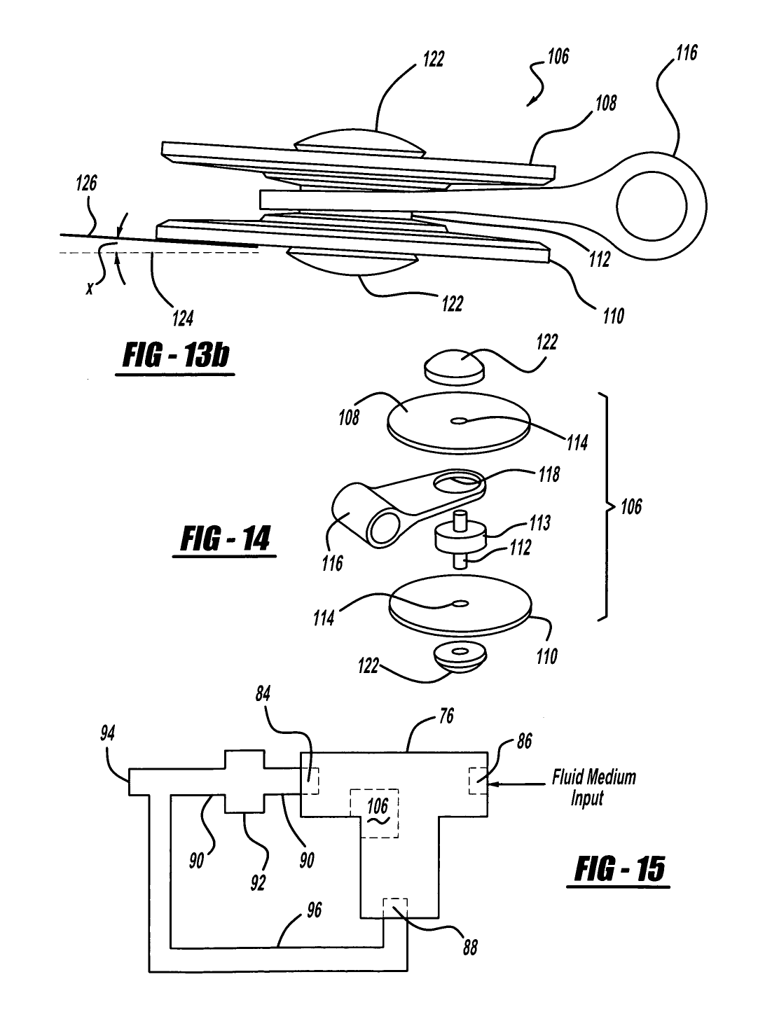

It is understood that alternatively, as shown in FIGS. 13(a)-(b), the raised bosses 109, 111 can be omitted such that the pin 112 is disposed through the apertures 114 of the first and second valve plates 108, 110 and the pivot arm aperture 118 associated with one end of the pivot arm 116. Preferably, both end caps 122 are formed on the pin 112 and no optional washer 120 is used. In an alternative embodiment of the invention shown in FIG. 14, the pin 112 has a pin flange 113 formed on the pin 112 wherein the pin flange 113 of the pin 112 has a greater diameter than the remainder of the pin 112 and can slide with respect to the pivot arm aperture 118. The pin flange 113 is at least partly disposed in the pivot arm aperture 118 portion located at one end of the pivot arm 116 and the rest of the pin 112 extends through the apertures 114 of both the first and second valve plates 108, 110 respectively.

The slidable connection of the first and second valve plates 108, 110 allows the valve plates 108, 110 to slide relative to the pivot arm 116 so that a space or gap is selectively formed between the pivot arm 116 and the first valve plate 108, or space is created between the pivot arm 116 and the second valve plate 110. The space accommodates radial movement and articulation of the first and second valve plates 108, 110 such that the first valve plate 108 can move relative to any geometry of the first seating surface 98 of the outlet port 84, and the second valve plate 110 can move relative to any geometry of the second seating surface 100 of the bypass port 88, thereby allowing the first and second valve plate 108, 110 to selectively close off the fluid medium from passing through either the outlet port 84 or the bypass port 88 respectively. It is understood that the slidable connection also forms a radial gap or clearance between flange 113 and the pivot arm 116 and aperture 118. The slidable connection and rotatability of the first and second valve plates 108, 110 about the circumference of the pin 112 accommodates radial movement, axial movement, and multi-axis-angular movement to compensate for any radial, axial, and multi-axis-angular misalignment, relative to any seating geometry to selectively create a tight seal or barrier for restricting the flow of the fluid medium. Since a change in the geometry of the first or second seating surface 98, 100 can occur due to ware, thermal expansion, or build up of foreign matter, including oil, dirt, grim, and dust this articulation feature allows the first and second valve plate 108, 110 to move in response to any geometry. It is understood that the valve member 106 can also be pivoted to an intermediate position such that the fluid medium can be variably directed through the outlet port 84 and bypass port 88 simultaneously, with the percentage of fluid medium passing through each port being dependent on the position of the valve member 106. It is further understood that when the bosses 109, 111 are formed on the first and second valve plates 108, 110, the bosses 109, 111 slide with respect to the pivot arm 116.

FIGS. 13(a) and 13(b) show an example of the articulation of the second valve plate 110 in response to any geometry of the second seating surface 100. Referring to FIG. 13(a), line 124 illustrates a first plane passing along the second seating surface 100, and the second valve plate 110 prior to articulation. Referring to FIG. 13(b), line 126 illustrates a second plane passing along the second seating surface 100 having a change in geometry, and the second valve plate 110 during an articulating movement. As shown, line 126 is at a different angle, x, than line 124. For example, x may be ten degrees and may reflect the amount of articulation and movement of the second valve plate 110, first valve plate 108, pin 112, and pivot arm 116 in response to the geometry of the second seating surface 100.

Referring to FIGS. 9-15, a shaft 128 extends through a passage 130 of the valve housing 78 and into a cylindrical tube 132 formed as part of the pivot arm 116 and disposed at an end of the pivot arm 116. The shaft 128 and cylindrical tube 132 are in press fit engagement to ensure that pivot arm 116 pivots with the shaft 128. A portion of the shaft 128 remains outside of the valve housing 78 to operably connect the shaft 128 to a lever assembly 134. The lever assembly 134 has a lever 136, washer 137, and lever pivot 138. The lever 136 is adapted on one end to receive the shaft 128 and is adapted on the other end to receive the lever pivot 138. The lever pivot 138 is adapted to receive an actuator 140. An optional bushing 142 can also be used in the passage 130 and receives the shaft 128 to further facilitate rotation of the shaft 128 in the passage 130. The actuator 140 can be an electric, hydraulic, pneumatic, and combinations thereof.

The first housing 80 can be operably connected to the second housing 82 by aligning a first flange 144 of the first housing 80 with a second flange 146 (shown in FIG. 11) of the second housing 82 and using a plurality of bolts 148 and the like to operably connect the first flange 144 to the second flange 146. The first flange 144 at least partly surrounds an opening in the housing that is not an opening of the outlet port 84. The second flange 146 at least partly surrounds an opening that is not an opening of the inlet port 86 or bypass port 88. It is understood that alternatively the first housing 80 and second housing 82 can be welded together, glued together, and the like.

In operation, when the engine operation is at a predetermined condition, the vehicle's electronic control unit can command the actuator 140, or some other device, to rotate the valve member 106 to a first position relative to the outlet port 84 or a second position relative to the bypass port 88. The actuator 140 controls the valve member 106 by commanding rotation of the lever assembly 134 and the shaft 128, which pivots the pivot arm 116. When it becomes necessary to direct all of the fluid medium through the bypass port 88, the valve member 106 is rotated into a position where the first valve plate 108 articulates in response to the first seating surface 98 of the outlet port 84, thereby restricting substantially all of the fluid medium from entering the outlet port 84 and allowing the fluid medium to flow through the bypass port 88. When it becomes necessary to direct all of the fluid medium through the outlet port 84, the valve member 106 rotates into a position where the second valve plate 110 articulates in response with the second seating surface 100 of the bypass port 88, thereby restricting substantially all of the fluid medium from entering the bypass port 88 and allowing the fluid medium to flow through the outlet port 84. It is further understood that the actuator 140 can control the valve member 106 to move to any position between the outlet port 84 and bypass port 88 to distribute the fluid medium therebetween. As illustrated in FIG. 15, when the fluid medium is directed through the outlet port 84 it can flow through a downstream path 90 to an operably connected structure 92 before exiting the downstream path 90. As further illustrated, when the fluid medium is directed through the bypass port 88 it can flow through an operably connected bypass path 96 that bypasses the structure 92.

In another embodiment, the method of assembling the bypass valve assembly 76 includes providing the first housing 80, the second housing 82, the valve member 106, the lever assembly 134, and the actuator 140. The first housing 80 comprises the outlet port 84 and a first flange 144 at least partly surrounding an opening that is not an opening associated with the outlet port 84. The second housing 82 has the inlet port 86, the bypass port 88, the passage 130, and the second flange 146 that at least partly surrounds an opening that is not an opening associated with the inlet port 86, bypass port 88, or passage 30. Assembling the valve member 106 includes at least partly inserting the raised bosses 109, 111 of the respective first and second valve plate 108, 110 into the pivot arm aperture portion 118. The pin 112 is then inserted through the second valve plate 110 aperture 114, the raised bosses 109, 111, and the first valve plate 108 aperture 114. The end cap 122 is then either operably connecting or formed on both ends of the pin 112. If the optional washer is used 120, the pin 112 is inserted through the washer 120 before operably connecting or forming the end cap 122 on the pin 112.

The valve member 106 is then inserted through the opening defined by the second flange 146 and placed inside the second housing 82 at a location that allows the valve member 106 to pivot between a first position and a second position such that the second valve plate 110 can align with the bypass port 88 and the first valve plate 108 can align with the outlet port 84. The shaft 128 is then inserted through the passage 130 disposed within the second housing 82 and into the cylindrical tube 132 of the pivot arm 116, and the other end of the shaft 128 is left outside of the second housing 82 for connecting to the lever assembly 134. If the optional bushing 142 is used, the bushing 142 is inserted in the passage 130 prior to inserting the shaft 128. One end of the lever 136 of the lever assembly 134 is operably connected to the shaft 128, and the other end of the lever 136 is operably connected to the lever pivot 138 and washer 137.

The first flange 144 of the first housing 80 is operably connected to the second flange 146 of the second housing 82 by a plurality of bolts 148 and the like such that the first flange 144 is aligned with the second flange 146. Alternatively, a gasket 150, which can be adapted to receive the plurality of bolts 148, can be placed between the first flange 144 and the second flange 146 before connecting the first housing 80 to the second housing 82. It is understood that the first housing 80 and second housing 82 can alternatively be welded together, glued together, and the like.

The actuator 140 is operably connected to the lever pivot 138 by a plurality of locking nuts 152, bolts, and the like. For added stability of the actuator 140, an attachment bracket 154 can be disposed on the actuator 140 and connected to the valve housing 78 by a plurality of actuator bolts 156.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A valve assembly, comprising:
a valve housing;
a first port formed in said valve housing;
a second port formed in said valve housing;
a third port formed in said valve housing;
said first, second, and third ports operable to receive or deliver a fluid medium flow;
a valve member operably connected to said valve housing for controlling a fluid medium flow associated with two of the three ports, said valve member including a first valve plate and a second valve plate facing in substantially opposite directions from each another, wherein said first valve plate articulates in radial, axial, and multi-axis-angular directions to selectively form a tight barrier with one of said ports to block the fluid medium flow through said port and said second valve plate articulates in radial, axial, and multi-axis-angular directions to selectively form a tight barrier with another of said ports to block the fluid medium flow through said port, or said valve member pivots to distribute the fluid medium flow therebetween.

2. The valve assembly according to claim 1, wherein said valve housing is a two piece valve housing having a first portion operably connected to a second portion, wherein a first flange of said first portion is aligned with a second flange of said second portion.

3. The valve assembly according to claim 1, wherein said valve member further comprises a pin slidably connected to a pivot arm, wherein said pin slides with respect to said pivot arm to allow said first valve plate and said second valve plate to articulate.

4. The valve assembly according to claim 1 further comprising an actuator operably connected to said valve member, wherein said actuator is selected from the group consisting of an electric actuator, a hydraulic actuator, a pneumatic actuator, and combinations thereof.

5. The valve assembly of claim 1 further comprising:
a first seating surface formed around an opening on one of said ports;
a second seating surface formed around an opening of another of said ports, wherein said first seating surface and said second seating surface each have a seating surface geometry and said first valve plate and said second valve plate articulate to accommodate for the seating surface geometries.

6. The valve assembly according to claim 1, wherein at least one of said first and second valve plates further comprises a boss slidably connected to a pivot arm, wherein said boss slides with respect to said pivot arm to allow said first valve plate and said second valve plate to articulate.

7. The valve assembly according to claim 1, further comprising a first seating surface and a second seating surface formed in said valve housing, wherein said first and second valve plates articulate to selectively form a tight barrier with said first and second seating surfaces to selectively block the fluid medium flow associated with two of the three ports.

8. The valve assembly according to claim 1, wherein said valve member is operably connected to said valve housing by inserting said valve member through an opening defined by a flange.

9. A bypass valve assembly comprising:
a valve housing including an inlet port, an outlet port, and a bypass port;
a first seating surface surrounding an opening of said outlet port;
a second seating surface surrounding an opening of said bypass port; and
a valve member disposed inside said valve housing, said valve member comprising first and second valve plates facing in substantially opposite directions from each other and slidably connected to a pivot arm, wherein a pin operably couples said first and second valve plates and said first and second valve plates can pivot 360 degrees about the circumference of said pin and slide along the longitudinal axis of said pin; wherein said pivot arm pivots said valve member to a first position and said first valve plate articulates relative to said first seating surface to inhibit substantially all of a fluid medium from flowing through said outlet port, or said valve member pivots to a second position and said second valve plate articulates relative to said second seating surface to inhibit substantially all of said fluid medium from flowing through said bypass port, or said valve member pivots to distribute said fluid medium therebetween.

10. The bypass valve assembly according to claim 9, wherein said valve housing is a two piece valve housing comprising a first housing operably connected to a second housing such that a flange of said first housing is aligned with a second flange of said second housing.

11. The bypass valve assembly according to claim 9, further comprising an actuator operably connected to said valve member, wherein said actuator is selected from the group consisting of an electric actuator, a hydraulic actuator, a pneumatic actuator, and combinations thereof.

12. The bypass valve assembly according to claim 9, wherein said valve member is operably connected to said valve housing by inserting said valve member through an opening defined by a flange.

13. The bypass valve assembly according to claim 9, wherein said first and second valve plates each further comprise an opposing boss slidably connected to a pivot arm, wherein said bosses are operably adapted to receive said pin and slide with respect to said pivot arm to allow said first valve plate and said second valve plate to articulate.

14. A valve arrangement comprising:
a valve housing having an inlet port, an outlet port, and a bypass port;
an upstream path connected to said valve housing through said inlet port;
a downstream path connected to said valve housing at said outlet port;
a bypass path connected to said valve housing at said bypass port, wherein said bypass path reconnects to said downstream path at a junction downstream of said valve housing;
a valve member operably connected to said valve housing, said valve member including a first valve plate and a second valve plate facing in substantially opposite directions from each other, wherein said first valve plate articulates to form a tight barrier with said outlet port when in a first position, and said second valve plate articulates to form a tight barrier with said second bypass port when in a second position;
a structure located in said downstream path between said valve housing and said junction, wherein said bypass path is used to direct fluid around said structure.

15. The valve arrangement according to claim 14, wherein said valve housing is a two-piece valve housing having a first portion operably connected to a second portion, wherein a flange of said first portion is aligned with a second flange of said second portion.

16. The valve arrangement according to claim 14, wherein said first and second valve plates are slidably connected to a pivot arm and articulate as said pivot arm moves between said first position and said second position.

17. The valve arrangement according to claim 14, further comprising an actuator operably connected to said valve member, wherein said actuator is selected from the group consisting of an electric actuator, a hydraulic actuator, a pneumatic actuator, and combinations thereof.

18. The bypass valve arrangement according to claim 14, wherein said structure is one selected from the group comprising an air cooler, an exhaust gas recirculation cooler, a turbine, a compressor, a condenser, a throttle body, and combinations thereof.

19. The valve arrangement according to claim 14 further comprising:
a first seating surface formed in said valve housing and surrounding an opening of said outlet port;
a second seating surface formed in said valve housing and surrounding an opening of said bypass port, wherein said first seating surface and said second seating surface each have a seating surface geometry, and said first valve member and said second valve member articulate to accommodate for said seating surface geometries.

20. A method of assembling a valve assembly comprising:
providing a first housing comprising a first port and an opening defined by a first flange;
providing a second housing comprising a second port, third port, a passage, and an opening defined by a second flange;
providing a first valve plate, a second valve plate, a pivot arm including a first end operable to receive a shaft, and a pin;
assembling a valve member by slidably connecting said pivot arm to said first and second valve plates disposed in substantially opposite directions and inserting a pin through an aperture of at least one of said first or second valve plates;
inserting said valve member through said opening defined by said second flange;
locating said valve member in a position to pivot between said first port, and one of said second or third ports, and any position therebetween;
inserting said shaft partly through said passage and rotatably connecting said shaft to said first end of said pivot arm;
providing a lever assembly including a lever, washer, and a lever pivot, wherein said lever is operably connected to said shaft;
operably connecting said first housing to said second housing, wherein said flange of said first housing is aligned with said second flange of said second housing; and
providing an actuator operably connected to said lever assembly, said actuator manipulating said lever assembly to rotate said shaft, wherein said valve member pivots to a first position for restricting a fluid medium from flowing through said first port, or said valve member pivots to a second position for restricting said fluid medium from flowing through said second or third port or pivots to any position therebetween.

21. The method of assembling a valve assembly according to claim 20 further comprising, inserting a bushing through said passage, inserting said shaft through said bushing, and rotatably connecting said shaft to said pivot arm, wherein said shaft rotates to pivot said pivot arm for pivoting said valve member to said first port, said second or third port, and any position therebetween.

22. The method of assembling a valve assembly according to claim 20 further comprising, providing a gasket seal operably connected to said flange and said second flange.
